(19) United States
(12) Patent Application Publication
(10) Pub. No.: US 2025/0156939 A1
(43) Pub. Date: May 15, 2025

(54) Technologies for Predictive Management of Customer Account Balance Attrition

(71) Applicant: The PNC Financial Services Group, Inc., Pittsburgh, PA (US)

(72) Inventors: Dongmei Wang, Charlotte, NC (US); Thenmozhi Radhakrishnan, McKinney, TX (US); Amanda McCracken, Westerville, OH (US); Lakhbir Lamba, Gibsonia, PA (US)

(21) Appl. No.: 18/939,821

(22) Filed: Nov. 7, 2024

Related U.S. Application Data
(60) Provisional application No. 63/597,726, filed on Nov. 10, 2023.

(51) Int. Cl. G06Q 40/02; G06N 20/20; G06Q 30/0207

(52) U.S. Cl. CPC G06Q 40/02; G06N 20/20; G06Q 30/0215

(57) ABSTRACT

Technologies for predictive management of customer account balance attrition include a compute device. The compute device includes circuitry configured to obtain data indicative of one or more attributes of a customer of a financial institution. The circuitry may also be configured to generate, from the obtained data, a feature set for use by an ensemble of machine-learning models trained to predict customer behavior, provide the feature set to the ensemble of machine-learning models to produce a prediction of whether the customer of the financial institution will be lost to (e.g., at least a portion of the customer's money will be transferred to) a competitor financial institution, obtain the prediction from the ensemble of machine-learning models, and perform, in response to a determination that the that the customer is predicted to be lost, a remedial action to reduce a likelihood of losing the customer.

### RELATED APPLICATIONS

This application claims the benefit of U.S. Provisional Application Ser. No. 63/597,726 filed Nov. 10, 2023 for “Technologies for Predictive Management of Customer Account Balance Attrition,” which is hereby incorporated by reference in its entirety.

### BACKGROUND

Interest rates paid by financial institutions may undergo cycles in which the rates rise for a period, then descend, and repeat. During times of rising rates, financial institutions with higher overhead, caused by employing a larger work force and/or maintaining more physical offices (e.g., branch offices) may struggle to provide the same interest rates as financial institutions that have comparatively lower overhead (e.g., by operating primary online, with fewer employees and physical offices). During such times, banking customers may be incentivized to move their money from the financial institutions with higher operating costs to those with lower operating costs, to obtain higher interest rates if the difference in interest rates is significant enough. Winning back banking customers who have switched to another bank can be an expensive process that incurs significant operating costs, further diminishing a financial institution's ability to pay relatively high interest rates.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements. The detailed description particularly refers to the accompanying figures in which:

FIG. 1 is a simplified block diagram of at least one embodiment of a system for providing predictive management of customer account balance attrition;

FIG. 2 is a simplified block diagram of at least one embodiment of a compute device of the system of FIG. 1;

FIGS. 3-6 are simplified block diagrams of at least one embodiment of a method for predictively managing customer balance attrition that may be performed by the system of FIG. 1;

FIG. 7 is a simplified block diagram of at least one embodiment of a method for training machine-learning models for use by the system of FIG. 1; and

FIG. 8 is a simplified diagram of data and operations that may be performed by the system of FIG. 1 in data aggregation, data transformation, and modeling phases to enable predictive management of customer account balance attrition.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

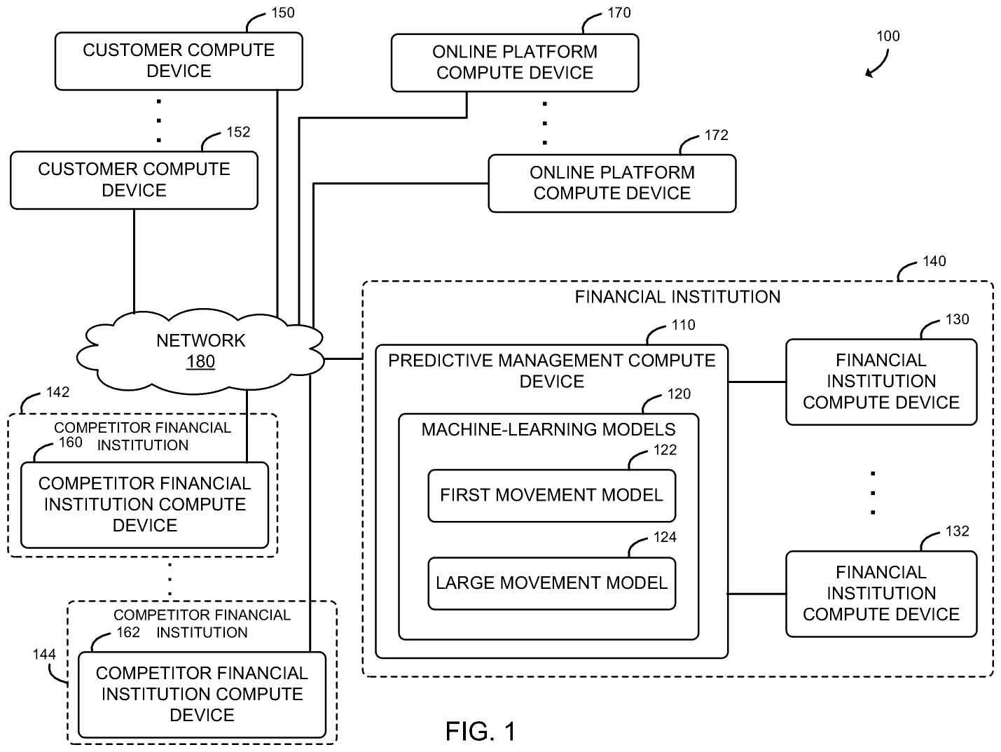

Referring now to FIG. 1, a system 100 for providing predictive management of customer account balance attrition includes, in the illustrative embodiment, a predictive management compute device 110 communicatively connected to a set of financial institution compute devices 130, 132 that process financial transactions on behalf of customers of a financial institution 140 (e.g., a bank). The compute devices 110, 130, 132 may be located in a data center (e.g., a facility housing compute devices, thermal control equipment, power management equipment, and networking equipment to support the operations of the compute devices). The system 100, in the illustrative embodiment, additionally includes customer compute devices 150, 152, competitor financial institution compute devices 160, 162, and online platform compute devices 170, 172. Using the customer compute devices 150, 152 (e.g., personal computers, notebook computers, tablets, smart phones, etc.), customers of the financial institution 140 may submit requests for transactions (e.g., pertaining to an account held with the financial institution 140), interact with competitor financial institution compute devices 160, 162 (e.g., compute devices utilized by financial institutions 142, 144 that compete with the financial institution 140 operating the compute devices 110, 130, 132 and that may have lower operating costs and offer higher interest rates) and/or perform activities on the online platform compute devices 170, 172 (e.g., compute devices used to operate social media platforms, e-commerce, etc.).

In operation, the predictive management compute device 110 obtains data from multiple sources within the system 100 pertaining to behaviors of the customers relative to their financial transactions (e.g., as reported by the financial institution compute devices 130, 132), such as transfers of money from accounts held with the financial institution 140 to other financial institutions 142, 144, activities relative to online platforms (e.g., indicative of their adeptness or preferences for computer-based interactions rather than physical interactions), macroeconomic variables, and data regarding competitor financial institutions 142, 144 (e.g., interest rates). The predictive management compute device 110 also transforms the data to produce a feature set usable as inputs to a set 120 of machine-learning models 122, 124. Further, the predictive management compute device 110 utilizes the machine learning models to predict future behavior of each customer. In doing so, the predictive management compute device 110 illustratively obtains, using a first movement model 122, a determination as to the likelihood (e.g., probability) that a given customer will make an initial transfer of money from an account with the financial institution 140 to an account with a competitor financial institution 142, 144. Further, the predictive management compute device 110 may obtain, using a large movement model 124, a determination as to the likelihood (e.g., probability) that a given customer will make a transaction that moves a relatively large (e.g., satisfying a threshold amount, such as a dollar amount, a predefined percentage of the customer's balance, etc.), from the customer's account with the financial institution 140 to a competitor financial institution 142, 144 (e.g., a bank that offers a higher interest rate, an online bank, etc.).

The predictions from these models 122, 124 enable the predictive management compute device 110 to determine which customers are most likely to leave the financial institution 140 for one or more of the competitor financial institutions 142, 144 (e.g., to obtain a higher interest rate). By identifying customers at risk of taking such actions, the predictive management compute device 110 enables the financial institution 140 to take selective remedial actions, such as offering increased interest rates to those customers. As such, the financial institution 140 can avoid incurring the costs of offering increased interest rates to all customers (e.g., including those customers who would not perceive as much of a benefit from the increased interest rates and who would forego higher interest rates for the convenience of physical in-person interactions offered by the financial institution) or spending the increased resources required to win back customers after they have left.

While a single predictive management compute device 110, two financial institution compute devices 130, 132, two customer compute devices 150, 152, two competitor financial institution compute devices 160, 162, and two online platform compute devices 170, 172 are shown for simplicity and clarity, it should be understood that the number of compute devices, in practice, may range in the tens, hundreds, thousands, or more. Likewise, it should be understood that the compute devices 110, 130, 132, 150, 152, 160, 162, 170, 172 may be distributed differently or perform different roles than the configuration shown in FIG. 1. Further, though shown as separate compute devices 110, 130, 132, 150, 152, 160, 162, 170, 172 in some embodiments, the functionality of one or more of the compute devices 110, 130, 132, 150, 152, 160, 162, 170, 172 may be combined into fewer compute devices and/or distributed across more compute devices than those shown in FIG. 1.

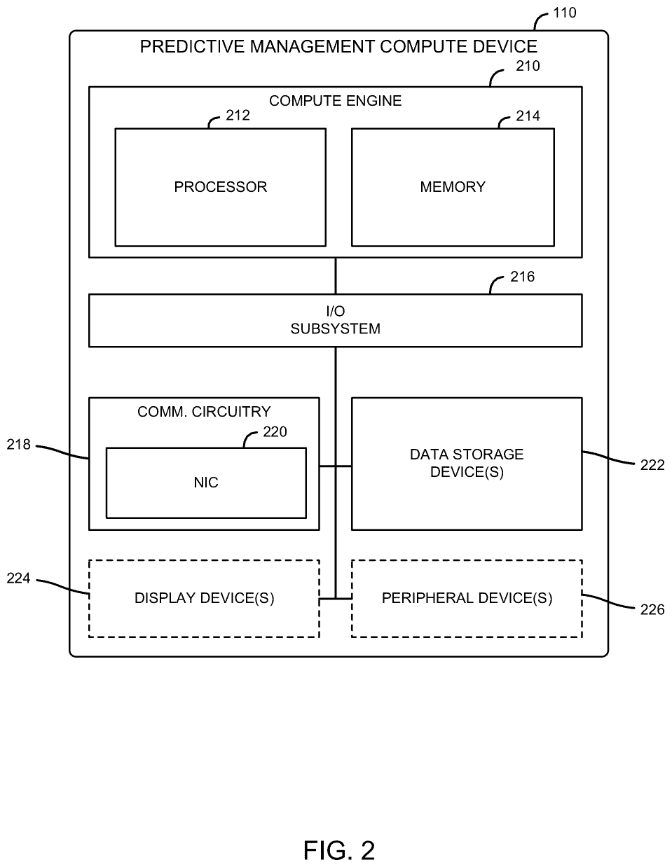

Referring now to FIG. 2, the illustrative predictive compute device 110 includes a compute engine 210, an input/output (I/O) subsystem 216, communication circuitry 218, and one or more data storage devices 222. In some embodiments, the predictive management compute device 110 may include one or more display devices 224 and/or one or more peripheral devices 226 (e.g., a mouse, a physical keyboard, etc.). In some embodiments, one or more of the illustrative components may be incorporated in, or otherwise form a portion of, another component. The compute engine 210 may be embodied as any type of device or collection of devices capable of performing various compute functions described below. In some embodiments, the compute engine 210 may be embodied as a single device such as an integrated circuit, an embedded system, a field-programmable gate array (FPGA), a system-on-a-chip (SOC), or other integrated system or device. Additionally, in the illustrative embodiment, the compute engine 210 includes or is embodied as a processor 212 and a memory 214. The processor 212 may be embodied as any type of processor capable of performing the functions described herein. For example, the processor 212 may be embodied as a single or multi-core processor(s), a microcontroller, or other processor or processing/controlling circuit. In some embodiments, the processor 212 may be embodied as, include, or be coupled to an FPGA, an application specific integrated circuit (ASIC), reconfigurable hardware or hardware circuitry, or other specialized hardware to facilitate performance of the functions described herein.

In embodiments, the processor 212 is capable of receiving, e.g., from the memory 214 or via the I/O subsystem 216, a set of instructions which when executed by the processor 212 cause the predictive management compute device 110 to perform one or more operations described herein. In embodiments, the processor 212 is further capable of receiving, e.g., from the memory 214 or via the I/O subsystem 216, one or more signals from external sources, e.g., from the peripheral devices 226 or via the communication circuitry 218 from an external compute device, external source, or external network. As one will appreciate, a signal may contain encoded instructions and/or information. In embodiments, once received, such a signal may first be stored, e.g., in the memory 214 or in the data storage device(s) 222, thereby allowing for a time delay in the receipt by the processor 212 before the processor 212 operates on a received signal. Likewise, the processor 212 may generate one or more output signals, which may be transmitted to an external device, e.g., an external memory or an external compute engine via the communication circuitry 218 or, e.g., to one or more display devices 224. In some embodiments, a signal may be subjected to a time shift in order to delay the signal. For example, a signal may be stored on one or more storage devices 222 to allow for a time shift prior to transmitting the signal to an external device. One will appreciate that the form of a particular signal will be determined by the particular encoding a signal is subject to at any point in its transmission (e.g., a signal stored will have a different encoding that a signal in transit, or, e.g., an analog signal will differ in form from a digital version of the signal prior to an analog-to-digital (A/D) conversion).

The main memory 214 may be embodied as any type of volatile (e.g., dynamic random access memory (DRAM), etc.) or non-volatile memory or data storage capable of performing the functions described herein. Volatile memory may be a storage medium that requires power to maintain the state of data stored by the medium. In some embodiments, all or a portion of the main memory 214 may be integrated into the processor 212. In operation, the main memory 214 may store various software and data used during operation such as database records, applications, libraries, and drivers.

The compute engine 210 is communicatively coupled to other components of the predictive management compute device 110 via the I/O subsystem 216, which may be embodied as circuitry and/or components to facilitate input/output operations with the compute engine 210 (e.g., with the processor 212 and the main memory 214) and other components of the predictive management compute device 110. For example, the I/O subsystem 216 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some embodiments, the I/O subsystem 216 may form a portion of a system-on-a-chip (SoC) and be incorporated, along with one or more of the processor 212, the main memory 214, and other components of the predictive management compute device 110, into the compute engine 210.

The communication circuitry 218 may be embodied as any communication circuit, device, or collection thereof, capable of enabling communications over a network between the predictive management compute device 110 and another device (e.g., a compute device 130, 132, 150, 152, 160, 162, 170, 172 etc.). The communication circuitry 218 may be configured to use any one or more communication technology (e.g., wired or wireless communications) and associated protocols (e.g., Ethernet, Wi-Fi®, WiMAX, Bluetooth®, etc.) to effect such communication.

The illustrative communication circuitry 218 includes a network interface controller (NIC) 220. The NIC 220 may be embodied as one or more add-in-boards, daughter cards, network interface cards, controller chips, chipsets, or other devices that may be used by the predictive management compute device 110 to connect with another compute device (e.g., a compute device 130, 132, 150, 152, 160, 162, 170, 172, etc.). In some embodiments, the NIC 220 may be embodied as part of a system-on-a-chip (SoC) that includes one or more processors, or included on a multichip package that also contains one or more processors. In some embodiments, the NIC 220 may include a local processor (not shown) and/or a local memory (not shown) that are both local to the NIC 220. Additionally or alternatively, in such embodiments, the local memory of the NIC 220 may be integrated into one or more components of the predictive management compute device 110 at the board level, socket level, chip level, and/or other levels.

Each data storage device 222, may be embodied as any type of device configured for short-term or long-term storage of data such as, for example, memory devices and circuits, memory cards, hard disk drives, solid-state drives, or other data storage device. Each data storage device 222 may include a system partition that stores data and firmware code for the data storage device 222 and one or more operating system partitions that store data files and executables for operating systems.

Each display device 224 may be embodied as any device or circuitry (e.g., a liquid crystal display (LCD), a light emitting diode (LED) display, a cathode ray tube (CRT) display, etc.) configured to display visual information (e.g., text, graphics, etc.) to a user. In some embodiments, a display device 224 may be embodied as a touch screen (e.g., a screen incorporating resistive touchscreen sensors, capacitive touchscreen sensors, surface acoustic wave (SAW) touchscreen sensors, infrared touchscreen sensors, optical imaging touchscreen sensors, acoustic touchscreen sensors, and/or other type of touchscreen sensors) to detect selections of on-screen user interface elements or gestures from a user.

In the illustrative embodiment, the components of the predictive management compute device 110 are housed in a single unit. However, in other embodiments, the components may be in separate housings, in separate racks of a data center, and/or spread across multiple data centers or other facilities. The compute devices 130, 132, 150, 152, 160, 162, 170, 172 may have components similar to those described in FIG. 2 with reference to the predictive management compute device 110. The description of those components of the predictive management compute device 110 is equally applicable to the description of components of the compute devices 130, 132, 150, 152, 160, 162, 170, 172. Further, it should be appreciated that any of the devices 110, 130, 132, 150, 152, 160, 162, 170, 172 may include other components, sub-components, and devices commonly found in a computing device, which are not discussed above in reference to the predictive management compute device 110 and not discussed herein for clarity of the description.

In the illustrative embodiment, the compute devices 110, 130, 132, 150, 152, 160, 162, 170, 172 are in communication via a network 180, which may be embodied as any type of wired or wireless communication network, including global networks (e.g., the internet), wide area networks (WANs), local area networks (LANs), digital subscriber line (DSL) networks, cable networks (e.g., coaxial networks, fiber networks, etc.), cellular networks (e.g., Global System for Mobile Communications (GSM), Long Term Evolution (LTE), Worldwide Interoperability for Microwave Access (WiMAX), 3G, 4G, 5G, etc.), a radio area network (RAN), or any combination thereof.

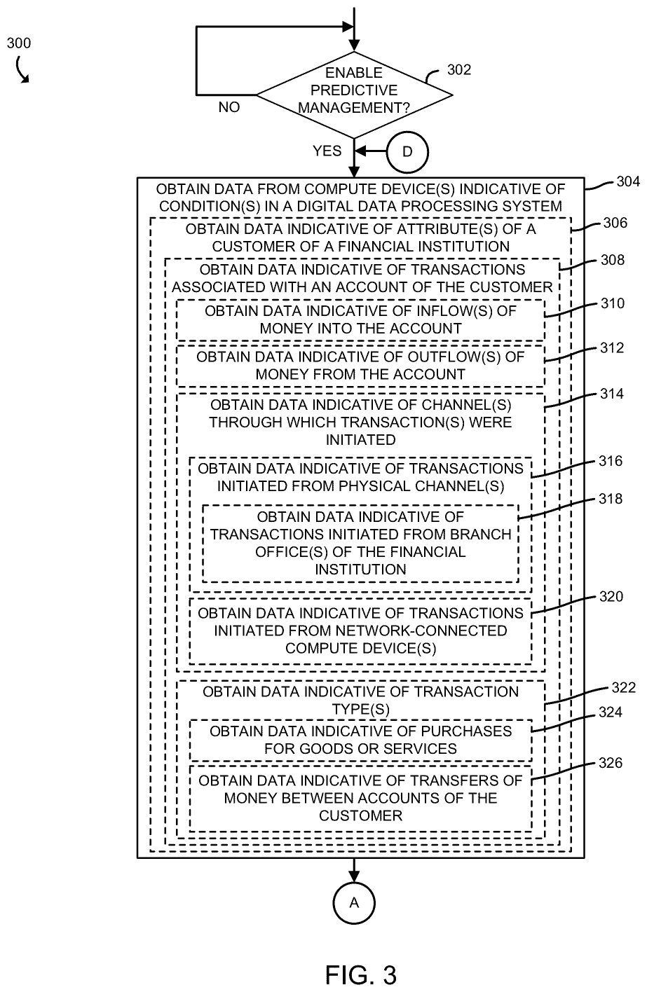

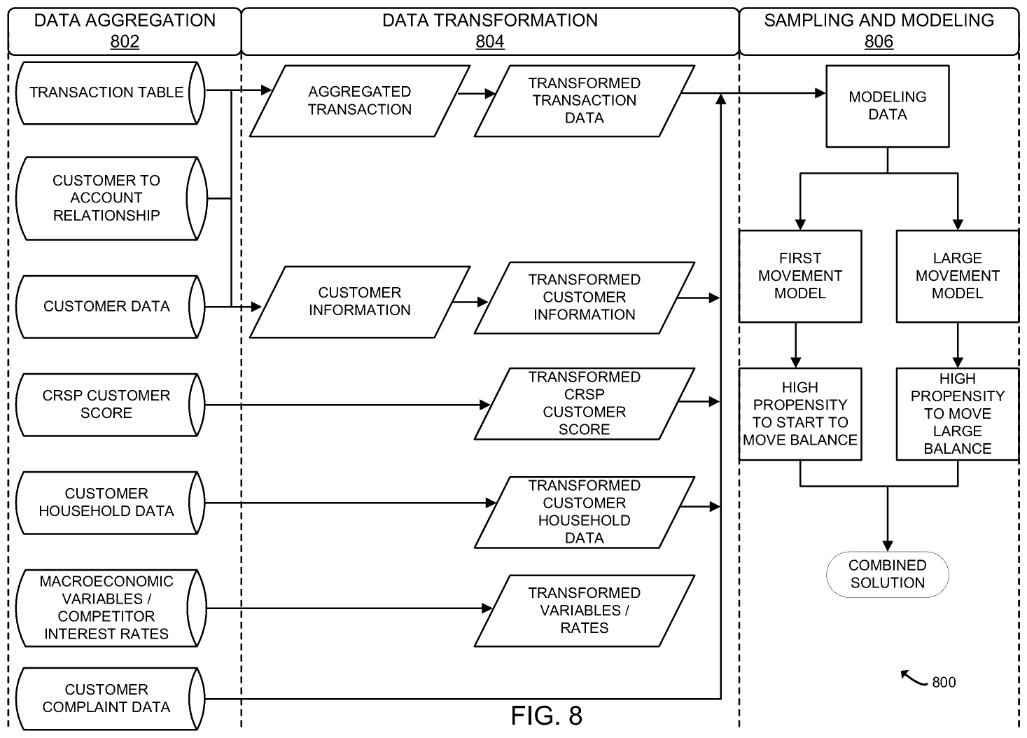

Referring now to FIG. 3, the system 100, and more specifically, the predictive management compute device 110, in the illustrative embodiment, may perform a method 300 for providing predictive management of customer account balance attrition (e.g., reducing the likelihood of customers moving the majority of their money to an account with a competitor financial institution). The method 300 begins with block 302 in which the predictive management compute device 110 determines whether to enable predictive management. In doing so, the predictive management compute device 110 may determine to enable predictive management in response to a determination that a configuration setting (e.g., in memory 214 or in storage 222) indicates to enable predictive management, in response to receiving a request from another compute device to enable predictive management, and/or based on other factors. Regardless, in response to a determination to enable predictive management, the method 300 advances to block 304 in which the predictive management compute device 110 obtains data from one or more compute devices (e.g., one or more of the compute devices 130, 132, 150, 152, 160, 162, 170, 172) in a digital data processing system (e.g., the system 100). The data collection operations correspond to section 802 of the high level flow 800 of data and operations utilized by the system 100 as illustrated in FIG. 8. In obtaining data, and as indicated in block 306, the predictive management compute device 110 may obtain data indicative of one or more attributes of a customer of a financial institution (e.g., the financial institution 140).

The predictive management compute device 110 may, obtain data indicative of transactions associated with an account of the customer, as indicated in block 308. For example, the predictive management compute device 110 may obtain data (e.g., from the financial institution compute devices 130, 132) indicative of inflows of money (e.g., deposits, payroll, etc.) into an account (e.g., a deposit account, such as a checking or savings account) of the customer, as indicated in block 310. Similarly, the predictive management compute device 110 may obtain data indicative of outflows (e.g., transfers, payments, etc.) of money from the account, as indicated in block 312. In some embodiments, the predictive management compute device 110 obtains data indicative of channels (e.g., mediums, means, modes of communication or operation, etc.) through which transactions (e.g., financial transactions associated with the customer) have been initiated, as indicated in block 314. The data indicative of the channels may be encoded in records of financial transactions containing an identifier of the source of a transaction (e.g., name, physical address, internet protocol address, or other identifier of the source). For example, and as indicated in block 316, the predictive management compute device 110 may obtain data indicative of transactions initiated from one or more physical channels. In doing so, the predictive management compute device 110 may obtain data indicative of transactions initiated from branch offices of the financial institution, as indicated in block 318. Additionally or alternatively, and as indicated in block 320, the predictive management compute device 110 may obtain data indicative of transactions initiated from network-connected compute devices (e.g., from the customer compute devices 150, 152).

The predictive management compute device 110 may also obtain data indicative of transaction types (e.g., automated clearing house (ACH), payments, utility, government, etc.) that have occurred with the customer account, as indicated in block 322. For example, and as indicated in block 324, the predictive management compute device 110 may obtain data indicative of purchases for goods or services (e.g., from online retailers and/or physical locations). In the illustrative embodiment, the predictive management computer device 110 may also obtain data indicative of transfers of money between accounts (e.g., financial accounts within the same financial institution 140 and/or across financial institutions 140, 142, 144) of the customer, as indicated in block 326. In some embodiments, the predictive management compute device 110 may obtain data that includes a shopping behavior score (e.g., a numeric value) indicative of a likelihood of that a customer will move new discretionary liquid balance into a bank, a price sensitivity score (e.g., a numeric value) indicative of an expected change in a customer's discretionary liquid balance for a unit change in reference rate, and/or a persistence score (e.g., a numeric value) indicative of an expected longevity of a customer's discretionary liquid balance.

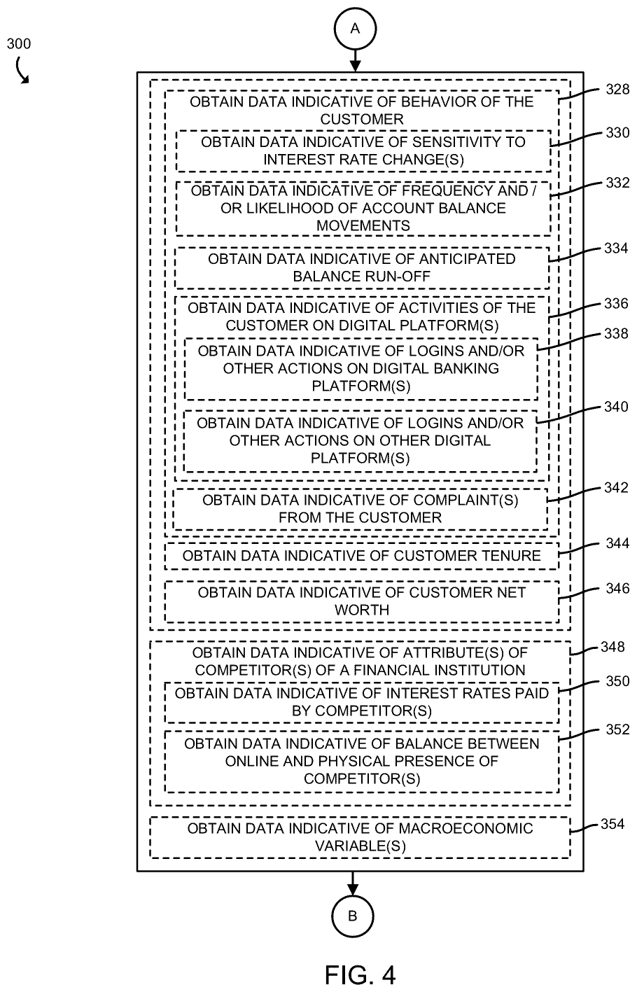

Referring now to FIG. 4, the predictive management compute device 110 may also obtain data indicative of behavior of the customer, as indicated in block 328. In doing so, and as indicated in block 330, the predictive management compute device 110 may obtain data indicative of a sensitivity of the customer to interest rate changes. For example, in some embodiments, the predictive management compute device 110 may obtain data indicating that the customer has transferred money between accounts within the financial institution 140 to favor (e.g., maintain more money in) accounts that provide higher interest rates than other accounts (e.g., favoring savings accounts over checking accounts), as indicated in block 330. Relatedly, in some embodiments, the predictive management compute device 110 may obtain data indicative of a frequency and/or likelihood of account balance movements, as indicated in block 332. That is, the predictive management compute device 110 may obtain data indicating that the customer moves money between accounts with a particular periodicity (e.g., indicating that the customer periodically reviews and adjusts allocations of money among accounts, such as to take advantage of higher interest rates as the available interest rates change). Such data may also indicate that the customer may be likely to move their money again within predefined time period (e.g., as judged from the present date) if a periodicity is indicated in the data.

As indicated in block 334, the predictive management compute device 110 may obtain data indicative of an anticipated balance run-off. That is, the predictive management compute device 110 may obtain data indicating that the customer is transferring money out of an account at a rate that exceeds the rate at which money is being deposited into the account, and at the rate of outflow from the account, the balance will reach zero on a particular date. As indicated in block 336, the predictive management compute device 110 may obtain data indicative of activities of the customer on one or more digital (e.g., online) platforms. For example, the predictive management compute device 110 may obtain data indicative of logins and/or other actions (e.g., bill pay, review of transactions, requests for customer support, etc.), on digital banking platforms (e.g., a website, an application executed by a financial institution application server (e.g., financial institution compute device 130, 132)), as indicated in block 338. The predictive management compute device 110 may obtain data indicative of logins and/or other actions on other digital platforms as well, as indicated in block 340. For example, the predictive management compute device 110 may obtain data indicative of social media postings from a customer and/or responsiveness to emails from the financial institution 140. Such data may be indicative of an adeptness and/or preference of the customer for computer-based interactions rather than in-person physical interactions and less sensitivity to whether a financial institution has physical branch offices available for use by the customer.

The predictive management compute device 110 may obtain data indicative of complaints made by the customer (e.g., indicating a willingness to leave for another financial institution), as indicated in block 342. Additionally or alternatively, the predictive management compute device 110 may obtain data indicative of customer tenure (e.g., the length of time the customer has held an account with the financial institution 140), as indicated in block 344. Another attribute that the predictive management compute device 110 may obtain data indicative of is the net worth of the customer (e.g., by summing the amount of money in accounts held by the customer, including investment accounts, determining a value of the customer's other property, such as based on estimates of house value, and/or other sources), as indicated in block 346. In block 348, the predictive management compute device 110 may obtain data indicative of one or more attributes of competitors of the financial institution 140. In doing so, the predictive management compute device 110 may obtain data indicative of interest rates paid by competitor financial institutions 142, 144 (e.g., based on advertisements from those competitor financial institutions), as indicated in block 350. Additionally, the predictive management compute device 110 may obtain data indicative of a balance between online and physical presences of competitor financial institutions 142, 144, (e.g., the number of branch offices each competitor financial institution 142, 144 has), as indicated in block 352. In some embodiments, the predictive management compute device 110 may obtain data indicative of macroeconomic variables (e.g., federal reserve interest rate, inflation rate, etc.), as indicated in block 354.

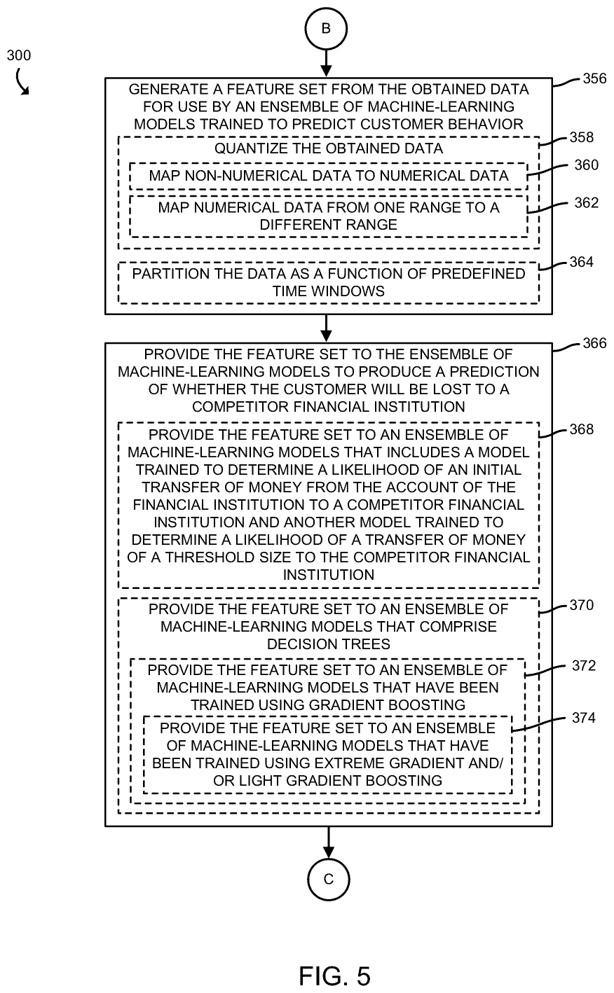

Referring now to FIG. 5, in block 356, the predictive management compute device 110, in the illustrative embodiment generates a feature set (e.g., a set of independent variables) from the obtained data (e.g., from block 304) for use by an ensemble of machine-learning models trained to predict customer behavior (e.g., the set 120 of models 122, 124). The generation of a feature set corresponds to section 804 in the high level flow 800 represented in FIG. 8. In generating a feature set, and as indicated in block 358, the predictive management compute device 110 may quantize (e.g., map to discrete numeric values) the obtained data. In generating the feature set, the predictive management compute device 110 may map non-numerical data (e.g., qualitative descriptions, words, names, etc.) to numerical data (e.g., by assigning each item of non-numerical data to a category that has an associated numeric value), as indicated in block 360. The predictive management compute device 110 may also map numerical data from one range to a different range (e.g., normalizing numeric values measured on different scales to a notionally common scale, etc.), as indicated in block 362. The predictive management compute device 110, in the illustrative embodiment, also partitions the data as a function of predefined time windows. That is, the predictive management compute device 110 may create data sets that are associated with predefined lengths of time (e.g., 30 days, 60 days, 90 days, a year, etc.). In some embodiments, the predictive management compute device 110 may produce summaries or digests (e.g., statistical summaries such as means, modes, variances, etc.) of those data sets (e.g., partitions) of the larger data set for use as elements in the feature set.

Subsequently, in block 366, the predictive management compute device 110 provides the feature set to the ensemble of machine-learning models to produce a prediction of whether the customer will be lost to (e.g., will transfer money to) a competitor financial institution 142, 144. Providing the feature set to the machine-learning models corresponds to section 806 of the high level flow 800 utilized by the system 100 as represented in FIG. 8. As indicated in block 368 of FIG. 5, the predictive management compute device 110, in the illustrative embodiment, provides the feature set to an ensemble (the set 120) of machine-learning models that includes a model (e.g., the model 122) trained to determine a likelihood of an initial transfer of money from the account of the customer with the financial institution 140 to a competitor financial institution 142, 144 and another model (e.g., the model 124) that is trained to determine a likelihood of a transfer of money (e.g., initiated by the customer) of a threshold size (e.g., a predefined threshold, such as a defined percentage of the balance in the customer's account, an absolute amount (e.g., a number of dollars), etc.) from the customer's account with the financial institution 140 to a competitor financial institution 142, 144.

As indicated in block 370, in providing the feature set to an ensemble of machine-learning models, the predictive management compute device 110 in the illustrative embodiment, provides the feature set to an ensemble of machine-learning models that comprise decision trees (e.g., rather than a set of neural networks or other architecture). Unlike other architectures, machine-learning models based on decision trees afford a greater degree of human understandability, as the path through the decision tree can be traced from the initial inputs to the final determination (e.g., prediction, inference, conclusion, etc.). The prediction management compute device 110 may provide the feature set to an ensemble of machine-learning models that have been trained using gradient boosting, as indicated in block 372. Gradient boosting is an algorithm that combines multiple weak learners into strong learners, in which each new model is trained to reduce the loss function (e.g., mean squared error, cross-entropy, etc.) of the previous model using a gradient descent process. In doing so, in the illustrative embodiment, the predictive management compute device 110 provides the feature set to an ensemble of machine-learning models that have been trained using extreme and/or light gradient boosting (e.g., a computationally efficient set of algorithms that enable scalable, distributed gradient-boosting), as indicated in block 374.

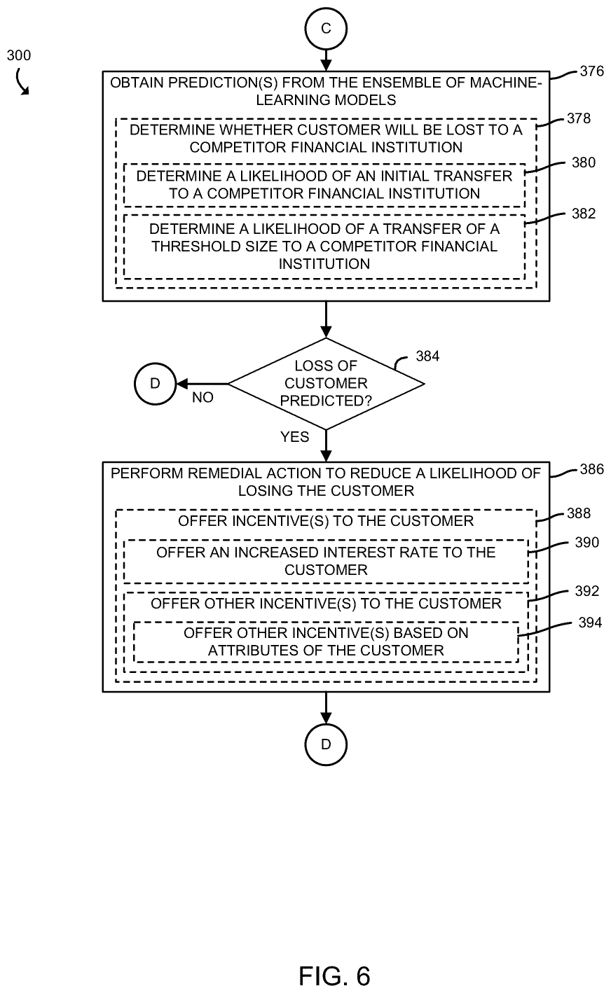

Referring now to FIG. 6, and as indicated in block 376, the predictive management compute device 110 obtains predictions from the ensemble 120 of machine-learning models 122, 124. In doing so, the predictive management compute device 110 determines whether the customer will be lost to a competitor financial institution 142, 144 (e.g., based on the determinations by the individual machine-learning models 122, 124 in the ensemble 120), as indicated in block 378. In the illustrative embodiment, the predictive management compute device 110 determines a likelihood (e.g., a probability, a confidence level, etc.) of an initial transfer of money from the account of the customer with the financial institution 140 to a competitor financial institution 142, 144, as indicated in block 380. That is, the predictive management compute device 110 obtains a determination from the model 122 based on the feature set provided to that model 122 in block 366. Typically, an initial relatively small transfer of money is made by a customer to a competitor financial institution as an initial step (e.g., to set up a financial account) in the transition from being a customer of one financial institution 140 to being a customer of another financial institution 142, 144. Additionally, in the illustrative embodiment, the predictive management compute device 110 determines a likelihood of a transfer of a threshold size (e.g., a defined percentage or dollar amount, larger than the initial transfer amount from block 380) from the account of the customer at the financial institution 140 to a competitor financial institution 142, 144, as indicated in block 382. In the illustrative embodiment, if either determination satisfies a threshold (e.g., a predefined probability or confidence level, such as greater than 50%), the predictive management compute device 110 determines that loss of the customer is predicted.

In block 384, the predictive management compute device 110 determines a subsequent course of action based on whether loss of the customer is predicted. If loss of the customer is not predicted, the method 300 loops back to block 302 in which the predictive management compute device 110 obtains additional data for further analysis. Alternatively, in response to a determination that the customer is predicted to leave the financial institution 140, the method 300 advances to block 386, in which the predictive management compute device 110 performs a remedial action to reduce the likelihood of losing the customer. In doing so, and as indicated in block 388, the predictive management compute device 110 may offer one or more incentives to the customer (e.g., in an email, in a message presented via a software application or web site used by the customer to interface with the financial institution 140, etc.). For example, the predictive management compute device 110 may offer an increased interest rate to the customer, such as a rate that is equal to the interest rate provided by the competitor financial institution 142, 144, as indicated in block 390. Additionally or alternatively, the predictive management compute device 110 may offer one or more other incentives to the customer, such as an enhanced feature set in a software application or web site interface used by the customer to interact with the financial institution, such as a visual analysis of spending habits, electronic deposit of checks via photographs of the checks, online bill pay, etc., as indicated in block 392. Other incentives may include more favorable rates on credit cards with the bank, discounted prices with a partnering airline, etc. The predictive management compute device 110 may select from the set of incentives based on attributes of the customer (e.g., attributes indicative of a sensitivity to interest rates, attributes indicative of a preference for online banking over in-person banking, etc.). Subsequently, the method 300 loops back to block 304 of FIG. 3 to obtain additional data for analysis.

Though the method 300 is described above with reference to a single customer for simplicity and clarity, the predictive management compute device 110 in the illustrative embodiment, performs the method on all or a selected subset of multiple customers of the financial institution 140. Further, though the operations are presented in a particular order, it should be understood that the operations could be performed in a different order and/or concurrently (e.g., obtaining data from compute devices in the system 100 while concurrently producing a feature set, obtaining predictions based on already-obtained data, and performing remedial actions on customers that have already been identified as likely convert to another financial institution 142, 144).

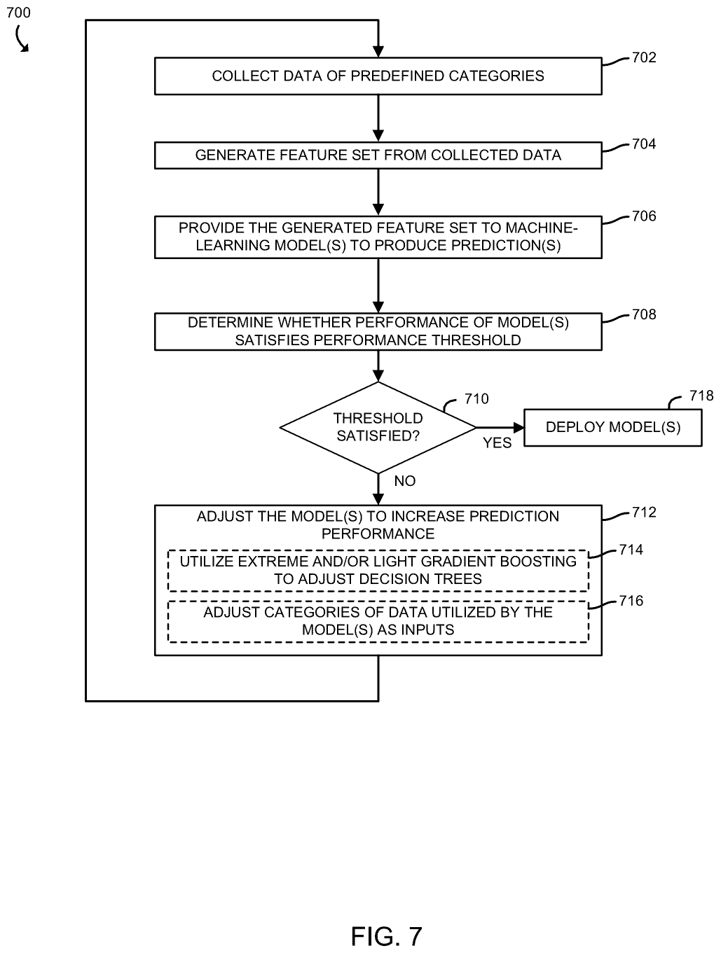

Referring now to FIG. 7, the system 100, and in the illustrative embodiment, the predictive management compute device 110 may perform a method 700 for training one or more machine-learning models (e.g., the models 122, 124) to predict customer behavior. In the illustrative embodiment, in block 702, the predictive management compute device 110 collects data of predefined categories (e.g., data indicative of transactions associated with an accounts of customers of a financial institution, data indicative of behaviors of the customers, data indicative of attributes of competitors of the financial institution, data indicative of macroeconomic variables, etc.). In block 704, the predictive management compute device 110 generates a feature set from the collected data (e.g., by converting the data to a format and/or range of values usable by machine-learning models, such as through operations similar to those described with reference to block 356). The predictive management compute device 110, in block 706, provides the feature set generated in block 704 to the machine-learning model(s) to produce predictions. In block 708, the predictive management compute device 110 determines whether the performance of the machine-learning model(s) in producing predictions satisfies a performance threshold. That is, using a set of known customer behaviors that resulted from the conditions represented in the data obtained in block 702, the predictive management compute device 110 determines the performance (e.g., precision, recall, etc.) of the model(s) in making predictions and compares the performance to a predefined threshold. The model(s), if untrained, may have an initial or default structure that produces predictions at a sub-optimal level of performance.

In block 710, the predictive management compute device 110 determines the subsequent course of action based on whether the performance of the model(s) satisfied the threshold. If not, the method 700 advances to block 712 in which the predictive management compute device 110 adjusts the model(s) to increase the performance of the model(s). In doing so, in at least some embodiments, the predictive management compute device 110 may utilize extreme and/or light gradient boosting to adjust a set of decision trees to produce more accurate predictions, as indicated in block 714. In other embodiments, the predictive management compute device 110 may utilize other techniques to adjust the model(s), such as Gaussian naive Bayes, Bernoulli naive Bayes, multinomial naive Bayes, logistic regression, stochastic gradient descent, passive aggressive classifiers, support vector classifier, K-nearest neighbor, and/or random forest techniques. Aside from adjusting the structure of the model(s), the predictive management compute device 110 may additionally adjust the categories of data available to the model(s) as inputs, such as by collecting additional sets of data or excluding data sets, as indicated in block 716. The method 700 subsequently loops back to block 702 to again collect data, generate the feature sets, and determine the performance of the model(s) based on the adjustments. Referring back to block 710, in response to a determination that one or more machine-learning model(s) satisfy the performance threshold, the predictive management compute device 110 deploys the model(s) (e.g., utilizes the models in the method 300), as indicated in block 718.

While certain illustrative embodiments have been described in detail in the drawings and the foregoing description, such an illustration and description is to be considered as exemplary and not restrictive in character, it being understood that only illustrative embodiments have been shown and described and that all changes and modifications that come within the spirit of the disclosure are desired to be protected. There exist a plurality of advantages of the present disclosure arising from the various features of the apparatus, systems, and methods described herein. It will be noted that alternative embodiments of the apparatus, systems, and methods of the present disclosure may not include all of the features described, yet still benefit from at least some of the advantages of such features. Those of ordinary skill in the art may readily devise their own implementations of the apparatus, systems, and methods that incorporate one or more of the features of the present disclosure.

### EXAMPLES

Illustrative examples of the technologies disclosed herein are provided below. An embodiment of the technologies may include any one or more, and any combination of, the examples described below.

Example 1 includes a compute device comprising circuitry configured to obtain, from one or more devices of a digital data processing system for processing financial transactions, data indicative of one or more attributes of a customer of a financial institution; generate, from the obtained data, a feature set for use by an ensemble of machine-learning models trained to predict customer behavior; provide the feature set to the ensemble of machine-learning models to produce a prediction of whether the customer of the financial institution will be lost to a competitor financial institution; obtain the prediction from the ensemble of machine-learning models; and perform, in response to a determination that the that the customer is predicted to be lost, a remedial action to reduce a likelihood of losing the customer.

Example 2 includes the subject matter of Example 1, and wherein to obtain the prediction comprises to determine one or more of a likelihood of an initial transfer of money from an account of the customer with the financial institution to an account of the customer with a competitor financial institution or a likelihood of a transfer of money satisfying a predefined threshold size from the account of the customer with the financial institution to the account of the customer with the competitor financial institution.

Example 3 includes the subject matter of any of Examples 1 and 2, and wherein to obtain data comprises to obtain data indicative of transactions associated with an account of the customer.

Example 4 includes the subject matter of any of Examples 1-3, and wherein to obtain data indicative of transactions associated with the account of the customer comprises to obtain data indicative of inflows and outflows of money from the account.

Example 5 includes the subject matter of any of Examples 1-4, and wherein to obtain data indicative of transactions comprises to obtain data indicative of one or more channels through which the transactions were initiated.

Example 6 includes the subject matter of any of Examples 1-5, and wherein to obtain data indicative of one or more channels comprises to obtain data indicative of transactions initiated from at least one branch office of the financial institution.

Example 7 includes the subject matter of any of Examples 1-6, and wherein to obtain data indicative of one or more channels comprises to obtain data indicative of transactions initiated from at least one network-connected compute device.

Example 8 includes the subject matter of any of Examples 1-7, and wherein to obtain data indicative of transactions comprises to obtain data indicative of one or more transaction types.

Example 9 includes the subject matter of any of Examples 1-8, and wherein to obtain data indicative of one or more transaction types comprises to obtain data indicative of purchases for goods or services.

Example 10 includes the subject matter of any of Examples 1-9, and wherein to obtain data indicative of one or more transaction types comprises to obtain data indicative of transfers of money between accounts of the customer.

Example 11 includes the subject matter of any of Examples 1-10, and wherein to obtain data comprises to obtain data indicative of behavior of the customer.

Example 12 includes the subject matter of any of Examples 1-11, and wherein to obtain data indicative of behavior of the customer comprises to obtain data indicative of sensitivity to interest rate changes.

Example 13 includes the subject matter of any of Examples 1-12, and wherein to obtain data indicative of behavior of the customer comprises to obtain data indicative of a frequency or likelihood of account balance movements.

Example 14 includes the subject matter of any of Examples 1-13, and wherein to obtain data indicative of behavior of the customer comprises to obtain data indicative of activities of the customer on one or more digital platforms.

Example 15 includes the subject matter of any of Examples 1-14, and wherein to obtain data indicative of behavior of the customer comprises to obtain data indicative of one or more complaints from the customer.

Example 16 includes the subject matter of any of Examples 1-15, and wherein to obtain data comprises to obtain data indicative of a tenure of the customer with the financial institution.

Example 17 includes the subject matter of any of Examples 1-16, and wherein to obtain data comprises to obtain data indicative of a net worth of the customer.

Example 18 includes the subject matter of any of Examples 1-17, and wherein the circuitry is further configured to obtain data indicative of one or more attributes of the competitor financial institution.

Example 19 includes the subject matter of any of Examples 1-18, and wherein to obtain data indicative of one or more attributes of the competitor financial institution comprises to obtain data indicative of an interest rate paid by the competitor institution.

Example 20 includes the subject matter of any of Examples 1-19, and wherein to obtain data indicative of one or more attributes of the competitor financial institution comprises to obtain data indicative of balance between an online and a physical presence of the competitor financial institution.

Example 21 includes the subject matter of any of Examples 1-20, and wherein the circuitry is further configured to obtain data indicative of one or more macroeconomic variables.

Example 22 includes the subject matter of any of Examples 1-21, and wherein to generate a feature set comprises to map non-numerical data to numerical data.

Example 23 includes the subject matter of any of Examples 1-22, and wherein to generate a feature set comprises to map numerical data from one range to a different range.

Example 24 includes the subject matter of any of Examples 1-23, and wherein to generate a feature set comprises to partition the data as a function of predefined time windows.

Example 25 includes the subject matter of any of Examples 1-24, and wherein to provide the feature set to an ensemble of machine-learning models comprises to provide the feature set to an ensemble of machine-learning models that includes a first model trained to determine a likelihood of an initial transfer of money from an account of the customer with the financial institution to an account of the customer with the competitor financial institution; and a second model trained to determine a likelihood of a transfer of money of a predefined threshold size from the account of the customer with the financial institution to the account of the customer with the competitor financial institution.

Example 26 includes the subject matter of any of Examples 1-25, and wherein to provide the feature set to an ensemble of machine-learning models comprises to provide the feature set to an ensemble of machine-learning models that comprise decision trees.

Example 27 includes the subject matter of any of Examples 1-26, and wherein to provide the feature set to an ensemble of machine-learning models comprises to provide the feature set to an ensemble of machine-learning models that have been trained using gradient boosting.

Example 28 includes the subject matter of any of Examples 1-27, and wherein to provide the feature set to an ensemble of machine-learning models comprises to provide the feature set to an ensemble of machine-learning models that have been trained using extreme and/or light gradient boosting.

Example 29 includes the subject matter of any of Examples 1-28, and wherein to perform the remedial action comprises to offer an increased interest rate to the customer.

Example 30 includes a method comprising obtaining, by a compute device and from one or more devices of a digital data processing system for processing financial transactions, data indicative of one or more attributes of a customer of a financial institution; generating, by the compute device and from the obtained data, a feature set for use by an ensemble of machine-learning models trained to predict customer behavior; providing, by the compute device, the feature set to the ensemble of machine-learning models to produce a prediction of whether the customer of the financial institution will be lost to a competitor financial institution; obtaining, by the compute device, the prediction from the ensemble of machine-learning models; and performing, by the compute device and in response to a determination that the that the customer is predicted to be lost, a remedial action to reduce a likelihood of losing the customer.

Example 31 includes the subject matter of Example 30, and wherein obtaining the prediction comprises determining, by the compute device, one or more of a likelihood of an initial transfer of money from an account of the customer with the financial institution to an account of the customer with a competitor financial institution or a likelihood of a transfer of money satisfying a predefined threshold size from the account of the customer with the financial institution to the account of the customer with the competitor financial institution.

Example 32 includes the subject matter of any of Examples 30 and 31, and wherein obtaining data comprises obtaining data indicative of transactions associated with an account of the customer.

Example 33 includes the subject matter of any of Examples 30-32, and wherein obtaining data indicative of transactions associated with the account of the customer comprises obtaining data indicative of inflows and outflows of money from the account.

Example 34 includes the subject matter of any of Examples 30-33, and wherein obtaining data indicative of transactions comprises obtaining data indicative of one or more channels through which the transactions were initiated.

Example 35 includes the subject matter of any of Examples 30-34, and wherein obtaining data indicative of one or more channels comprises obtaining data indicative of transactions initiated from at least one branch office of the financial institution.

Example 36 includes the subject matter of any of Examples 30-35, and wherein obtaining data indicative of one or more channels comprises obtaining data indicative of transactions initiated from at least one network-connected compute device.

Example 37 includes the subject matter of any of Examples 30-36, and wherein obtaining data indicative of transactions comprises obtaining data indicative of one or more transaction types.

Example 38 includes the subject matter of any of Examples 30-37, and wherein obtaining data indicative of one or more transaction types comprises obtaining data indicative of purchases for goods or services.

Example 39 includes the subject matter of any of Examples 30-38, and wherein obtaining data indicative of one or more transaction types comprises obtaining data indicative of transfers of money between accounts of the customer.

Example 40 includes the subject matter of any of Examples 30-39, and wherein obtaining data comprises obtaining data indicative of behavior of the customer.

Example 41 includes the subject matter of any of Examples 30-40, and wherein obtaining data indicative of behavior of the customer comprises obtaining data indicative of sensitivity to interest rate changes.

Example 42 includes the subject matter of any of Examples 30-41, and wherein obtaining data indicative of behavior of the customer comprises obtaining data indicative of a frequency or likelihood of account balance movements.

Example 43 includes the subject matter of any of Examples 30-42, and wherein obtaining data indicative of behavior of the customer comprises obtaining data indicative of activities of the customer on one or more digital platforms.

Example 44 includes the subject matter of any of Examples 30-43, and wherein obtaining data indicative of behavior of the customer comprises obtaining data indicative of one or more complaints from the customer.

Example 45 includes the subject matter of any of Examples 30-44, and wherein obtaining data comprises obtaining data indicative of a tenure of the customer with the financial institution.

Example 46 includes the subject matter of any of Examples 30-45, and wherein obtaining data comprises obtaining data indicative of a net worth of the customer.

Example 47 includes the subject matter of any of Examples 30-46, and further including obtaining, by the compute device, data indicative of one or more attributes of the competitor financial institution.

Example 48 includes the subject matter of any of Examples 30-47, and wherein obtaining data indicative of one or more attributes of the competitor financial institution comprises obtaining data indicative of an interest rate paid by the competitor institution.

Example 49 includes the subject matter of any of Examples 30-48, and wherein obtaining data indicative of one or more attributes of the competitor financial institution comprises obtaining data indicative of balance between an online and a physical presence of the competitor financial institution.

Example 50 includes the subject matter of any of Examples 30-49, and further including obtaining, by the compute device, data indicative of one or more macroeconomic variables.

Example 51 includes the subject matter of any of Examples 30-50, and wherein generating a feature set comprises mapping non-numerical data to numerical data.

Example 52 includes the subject matter of any of Examples 30-51, and wherein generating a feature set comprises mapping numerical data from one range to a different range.

Example 53 includes the subject matter of any of Examples 30-52, and wherein generating a feature set comprises partitioning the data as a function of predefined time windows.

Example 54 includes the subject matter of any of Examples 30-53, and wherein providing the feature set to an ensemble of machine-learning models comprises providing the feature set to an ensemble of machine-learning models that includes a first model trained to determine a likelihood of an initial transfer of money from an account of the customer with the financial institution to an account of the customer with the competitor financial institution; and a second model trained to determine a likelihood of a transfer of money of a predefined threshold size from the account of the customer with the financial institution to the account of the customer with the competitor financial institution.

Example 55 includes the subject matter of any of Examples 30-54, and wherein providing the feature set to an ensemble of machine-learning models comprises providing the feature set to an ensemble of machine-learning models that comprise decision trees.

Example 56 includes the subject matter of any of Examples 30-55, and wherein providing the feature set to an ensemble of machine-learning models comprises providing the feature set to an ensemble of machine-learning models that have been trained using gradient boosting.

Example 57 includes the subject matter of any of Examples 30-56, and wherein providing the feature set to an ensemble of machine-learning models comprises providing the feature set to an ensemble of machine-learning models that have been trained using extreme and/or light gradient boosting.

Example 58 includes the subject matter of any of Examples 30-57, and wherein performing the remedial action comprises offering an increased interest rate to the customer.

Example 59 includes one or more machine-readable storage media comprising a plurality of instructions stored thereon that, in response to being executed, cause a compute device to obtain, from one or more devices of a digital data processing system for processing financial transactions, data indicative of one or more attributes of a customer of a financial institution; generate, from the obtained data, a feature set for use by an ensemble of machine-learning models trained to predict customer behavior; provide the feature set to the ensemble of machine-learning models to produce a prediction of whether the customer of the financial institution will be lost to a competitor financial institution; obtain the prediction from the ensemble of machine-learning models; and perform, in response to a determination that the that the customer is predicted to be lost, a remedial action to reduce a likelihood of losing the customer.

Example 60 includes the subject matter of Example 59, and wherein to obtain the prediction comprises to determine one or more of a likelihood of an initial transfer of money from an account of the customer with the financial institution to an account of the customer with a competitor financial institution or a likelihood of a transfer of money satisfying a predefined threshold size from the account of the customer with the financial institution to the account of the customer with the competitor financial institution.

Example 61 includes the subject matter of any of Examples 59 and 60, and wherein to obtain data comprises to obtain data indicative of transactions associated with an account of the customer.

Example 62 includes the subject matter of any of Examples 59-61, and wherein to obtain data indicative of transactions associated with the account of the customer comprises to obtain data indicative of inflows and outflows of money from the account.

Example 63 includes the subject matter of any of Examples 59-62, and wherein to obtain data indicative of transactions comprises to obtain data indicative of one or more channels through which the transactions were initiated.

Example 64 includes the subject matter of any of Examples 59-63, and wherein to obtain data indicative of one or more channels comprises to obtain data indicative of transactions initiated from at least one branch office of the financial institution.

Example 65 includes the subject matter of any of Examples 59-64, and wherein to obtain data indicative of one or more channels comprises to obtain data indicative of transactions initiated from at least one network-connected compute device.

Example 66 includes the subject matter of any of Examples 59-65, and wherein to obtain data indicative of transactions comprises to obtain data indicative of one or more transaction types.

Example 67 includes the subject matter of any of Examples 59-66, and wherein to obtain data indicative of one or more transaction types comprises to obtain data indicative of purchases for goods or services.

Example 68 includes the subject matter of any of Examples 59-67, and wherein to obtain data indicative of one or more transaction types comprises to obtain data indicative of transfers of money between accounts of the customer.

Example 69 includes the subject matter of any of Examples 59-68, and wherein to obtain data comprises to obtain data indicative of behavior of the customer.

Example 70 includes the subject matter of any of Examples 59-69, and wherein to obtain data indicative of behavior of the customer comprises to obtain data indicative of sensitivity to interest rate changes.

Example 71 includes the subject matter of any of Examples 59-70, and wherein to obtain data indicative of behavior of the customer comprises to obtain data indicative of a frequency or likelihood of account balance movements.

Example 72 includes the subject matter of any of Examples 59-71, and wherein to obtain data indicative of behavior of the customer comprises to obtain data indicative of activities of the customer on one or more digital platforms.

Example 73 includes the subject matter of any of Examples 59-72, and wherein to obtain data indicative of behavior of the customer comprises to obtain data indicative of one or more complaints from the customer.

Example 74 includes the subject matter of any of Examples 59-73, and wherein to obtain data comprises to obtain data indicative of a tenure of the customer with the financial institution.

Example 75 includes the subject matter of any of Examples 59-74, and wherein to obtain data comprises to obtain data indicative of a net worth of the customer.

Example 76 includes the subject matter of any of Examples 59-75, and wherein the instructions additionally cause the compute device to obtain data indicative of one or more attributes of the competitor financial institution.

Example 77 includes the subject matter of any of Examples 59-76, and wherein to obtain data indicative of one or more attributes of the competitor financial institution comprises to obtain data indicative of an interest rate paid by the competitor institution.

Example 78 includes the subject matter of any of Examples 59-77, and wherein to obtain data indicative of one or more attributes of the competitor financial institution comprises to obtain data indicative of balance between an online and a physical presence of the competitor financial institution.

Example 79 includes the subject matter of any of Examples 59-78, and wherein the instructions additionally cause the compute device to obtain data indicative of one or more macroeconomic variables.

Example 80 includes the subject matter of any of Examples 59-79, and wherein to generate a feature set comprises to map non-numerical data to numerical data.

Example 81 includes the subject matter of any of Examples 59-80, and wherein to generate a feature set comprises to map numerical data from one range to a different range.

Example 82 includes the subject matter of any of Examples 59-81, and wherein to generate a feature set comprises to partition the data as a function of predefined time windows.

Example 83 includes the subject matter of any of Examples 59-82, and wherein to provide the feature set to an ensemble of machine-learning models comprises to provide the feature set to an ensemble of machine-learning models that includes a first model trained to determine a likelihood of an initial transfer of money from an account of the customer with the financial institution to an account of the customer with the competitor financial institution; and a second model trained to determine a likelihood of a transfer of money of a predefined threshold size from the account of the customer with the financial institution to the account of the customer with the competitor financial institution.

Example 84 includes the subject matter of any of Examples 59-83, and wherein to provide the feature set to an ensemble of machine-learning models comprises to provide the feature set to an ensemble of machine-learning models that comprise decision trees.

Example 85 includes the subject matter of any of Examples 59-84, and wherein to provide the feature set to an ensemble of machine-learning models comprises to provide the feature set to an ensemble of machine-learning models that have been trained using gradient boosting.

Example 86 includes the subject matter of any of Examples 59-85, and wherein to provide the feature set to an ensemble of machine-learning models comprises to provide the feature set to an ensemble of machine-learning models that have been trained using extreme and/or light gradient boosting.

Example 87 includes the subject matter of any of Examples 59-86, and wherein to perform the remedial action comprises to offer an increased interest rate to the customer.

Example 88 includes a compute device comprising circuitry configured to collect data associated with one of a set of defined categories of data; generate a feature set from the collected data; provide the generated feature set to a set of machine-learning models to produce one or more predictions pertaining to behavior of a customer of a financial institution; determine whether a performance of the one or more machine-learning models satisfies a performance threshold; and adjust, in response to a determination that the performance threshold is not satisfied, one or more of the models to increase the performance of the one or more models.

Example 89 includes the subject matter of Example 88, and wherein to adjust the one or more models comprises to utilize extreme and/or light gradient boosting to adjust one or more decision trees in the one or more models.

Example 90 includes the subject matter of any of Examples 88 and 89, and wherein to adjust the one or models comprises to adjust one or more of the categories of data utilized as inputs for the one or more models.

Example 91 includes a method comprising collecting, by a compute device, data associated with one of a set of defined categories of data; generating, by the compute device, a feature set from the collected data; providing, by the compute device, the generated feature set to a set of machine-learning models to produce one or more predictions pertaining to behavior of a customer of a financial institution; determining, by the compute device, whether a performance of the one or more machine-learning models satisfies a performance threshold; and adjusting, by the compute device and in response to a determination that the performance threshold is not satisfied, one or more of the models to increase the performance of the one or more models.

Example 92 includes the subject matter of Example 91, and wherein adjusting the one or more models comprises utilizing extreme and/or light gradient boosting to adjust one or more decision trees in the one or more models.

Example 93 includes the subject matter of any of Examples 91 and 92, and wherein adjusting the one or models comprises adjusting one or more of the categories of data utilized as inputs for the one or more models.

Example 94 includes one or more machine-readable storage media comprising a plurality of instructions stored thereon that, in response to being executed, cause a compute device to collect data associated with one of a set of defined categories of data; generate a feature set from the collected data; provide the generated feature set to a set of machine-learning models to produce one or more predictions pertaining to behavior of a customer of a financial institution; determine whether a performance of the one or more machine-learning models satisfies a performance threshold; and adjust, in response to a determination that the performance threshold is not satisfied, one or more of the models to increase the performance of the one or more models.

Example 95 includes the subject matter of Example 94, and wherein to adjust the one or more models comprises to utilize extreme and/or light gradient boosting to adjust one or more decision trees in the one or more models.

Example 96 includes the subject matter of any of Examples 94 and 95, and wherein to adjust the one or models comprises to adjust one or more of the categories of data utilized as inputs for the one or more models.

1. A compute device comprising:
circuitry configured to:
obtain, from one or more devices of a digital data processing system for processing financial transactions, data indicative of one or more attributes of a customer of a financial institution;
generate, from the obtained data, a feature set for use by an ensemble of machine-learning models trained to predict customer behavior;
provide the feature set to the ensemble of machine-learning models to produce a prediction of whether the customer of the financial institution will be lost to a competitor financial institution;
obtain the prediction from the ensemble of machine-learning models; and
perform, in response to a determination that the that the customer is predicted to be lost, a remedial action to reduce a likelihood of losing the customer.

2. The compute device of claim 1, wherein to obtain the prediction comprises to determine one or more of a likelihood of an initial transfer of money from an account of the customer with the financial institution to an account of the customer with a competitor financial institution or a likelihood of a transfer of money satisfying a predefined threshold size from the account of the customer with the financial institution to the account of the customer with the competitor financial institution.

3. The compute device of claim 1, wherein to obtain data comprises to obtain data indicative of transactions regarding inflows and outflows of money from an account of the customer.

4. The compute device of claim 3, wherein to obtain data indicative of transactions comprises to obtain data indicative of one or more channels through which the transactions were initiated.

5. The compute device of claim 4, wherein to obtain data indicative of one or more channels comprises to obtain data indicative of transactions initiated from at least one: (i) branch office of the financial institution; and/or (ii) network-connected compute device.

6. The compute device of claim 3, wherein to obtain data indicative of transactions comprises to obtain data indicative of: (i) purchases for goods or services; and/or (ii) transfers of money between accounts of the customer.

7. The compute device of claim 1, wherein to obtain data comprises to obtain data indicative of behavior of the customer comprising: (i) sensitivity to interest rate changes; (ii) frequency or likelihood of account balance movements; (iii) activities of the customer on one or more digital platforms; and/or (iv) one or more complaints from the customer.

8. The compute device of claim 1, wherein the circuitry is further configured to obtain data indicative of one or more attributes of the competitor financial institution comprising: (i) an interest rate paid by the competitor institution; and/or a balance between an online and a physical presence of the competitor financial institution.

9. The compute device of claim 1, wherein to generate a feature set comprises one or more of: (i) to map non-numerical data to numerical data; (ii) to map numerical data from one range to a different range; and/or (iii) to partition the data as a function of predefined time windows.

10. The compute device of claim 1, wherein to provide the feature set to an ensemble of machine-learning models comprises to provide the feature set to an ensemble of machine-learning models that includes:
a first model trained to determine a likelihood of an initial transfer of money from an account of the customer with the financial institution to an account of the customer with the competitor financial institution; and
a second model trained to determine a likelihood of a transfer of money of a predefined threshold size from the account of the customer with the financial institution to the account of the customer with the competitor financial institution.

11. The compute device of claim 1, wherein to provide the feature set to an ensemble of machine-learning models comprises one or more of: (i) to provide the feature set to an ensemble of machine-learning models that comprise decision trees; (ii) to provide the feature set to an ensemble of machine-learning models that have been trained using gradient boosting; and/or to provide the feature set to an ensemble of machine-learning models that have been trained using extreme and/or light gradient boosting.

12. The compute device of claim 1, wherein to perform the remedial action comprises to offer an increased interest rate to the customer.

13. A method comprising:
obtaining, by a compute device and from one or more devices of a digital data processing system for processing financial transactions, data indicative of one or more attributes of a customer of a financial institution;
generating, by the compute device and from the obtained data, a feature set for use by an ensemble of machine-learning models trained to predict customer behavior;
providing, by the compute device, the feature set to the ensemble of machine-learning models to produce a prediction of whether the customer of the financial institution will be lost to a competitor financial institution;
obtaining, by the compute device, the prediction from the ensemble of machine-learning models; and
performing, by the compute device and in response to a determination that the that the customer is predicted to be lost, a remedial action to reduce a likelihood of losing the customer.

14. The method of claim 13, wherein obtaining the prediction comprises determining, by the compute device, one or more of a likelihood of an initial transfer of money from an account of the customer with the financial institution to an account of the customer with a competitor financial institution or a likelihood of a transfer of money satisfying a predefined threshold size from the account of the customer with the financial institution to the account of the customer with the competitor financial institution.

15. The method of claim 13, wherein obtaining data comprises obtaining data indicative of transactions regarding inflows and outflows of money from an account of the customer.

16. The method of claim 13, wherein obtaining data comprises obtaining data indicative of behavior of the customer comprising: (i) sensitivity to interest rate changes; (ii) frequency or likelihood of account balance movements; (iii) activities of the customer on one or more digital platforms; and/or (iv) one or more complaints from the customer.

17. The method of claim 13, wherein providing the feature set to an ensemble of machine-learning models comprises providing the feature set to an ensemble of machine-learning models that includes:
a first model trained to determine a likelihood of an initial transfer of money from an account of the customer with the financial institution to an account of the customer with the competitor financial institution; and
a second model trained to determine a likelihood of a transfer of money of a predefined threshold size from the account of the customer with the financial institution to the account of the customer with the competitor financial institution.

18. The method of claim 13, wherein providing the feature set to an ensemble of machine-learning models comprises providing the feature set to an ensemble of machine-learning models that comprise decision trees.

19. The method of claim 13, wherein providing the feature set to an ensemble of machine-learning models comprises providing the feature set to an ensemble of machine-learning models that have been trained using gradient boosting.

20. One or more machine-readable storage media comprising a plurality of instructions stored thereon that, in response to being executed, cause a compute device to:
obtain, from one or more devices of a digital data processing system for processing financial transactions, data indicative of one or more attributes of a customer of a financial institution;
generate, from the obtained data, a feature set for use by an ensemble of machine-learning models trained to predict customer behavior;
provide the feature set to the ensemble of machine-learning models to produce a prediction of whether the customer of the financial institution will be lost to a competitor financial institution;
obtain the prediction from the ensemble of machine-learning models; and
perform, in response to a determination that the that the customer is predicted to be lost, a remedial action to reduce a likelihood of losing the customer.
